(19) United States
(12) Patent Application Publication
(10) Pub. No.: US 2019/0285408 A1
(43) Pub. Date: Sep. 19, 2019

(54) BASE OF MEASUREMENT APPARATUS

(71) Applicant: Mitutoyo Corporation, Kawasaki (JP)

(72) Inventors: Kanae Kobayashi, Tochigi (JP); Tomohiro Usui, Tochigi (JP); Shingo Kiyotani, Tochigi (JP); Tatsuya Terauchi, Tochigi (JP)

(21) Appl. No.: 16/352,336

(22) Filed: Mar. 13, 2019

(30) Foreign Application Priority Data
Mar. 15, 2018 (JP) 2018-047604

(51) Int. Cl. G01B 21/04

(52) U.S. Cl. CPC G01B 21/045

(57) ABSTRACT

A base of a measurement apparatus in which decrease in strength can be prevented while reducing weight is achieved. A base (10) of a three-dimensional measurement apparatus (1) configured to measure a workpiece (W) with a probe (30) includes a placement unit (12) on which the workpiece (W) is placed, and a guiding unit (14) provided on a side surface (12e) side of the placement unit (12), and configured to guide a column (22) supporting the probe (30), movable in the movement direction. A guiding unit one end (14c) and a guiding unit other end (14d) of the guiding unit (14) in the movement direction extend out of a placement unit one end (12c) and a placement unit other end (12d) of the placement unit (12) in the movement direction.

### TECHNICAL FIELD

The present invention relates to a base of a measurement apparatus configured to measure an object to be measured with a probe.

### BACKGROUND ART

As one of measurement apparatuses, coordinate measuring machines are used that are each configured to measure coordinates or the like of an object to be measured on a base by moving a probe in orthogonal three-axis directions (refer to Patent Literature 1), for example. The base has an integral configuration of a placement unit on which an object to be measured is placed, and a guiding unit configured to guide a movement mechanism configured to move with retaining the probe.

### CITATION LIST

### Patent Literature

Patent Literature 1: JP 5486416 B

### SUMMARY OF INVENTION

### Technical Problem

The above-described base is made from a stone, for example, and formed by cutting the stone into a shape that conforms to the placement unit and the guiding unit. In the base described above, strength is required and thus the base is made with a large thickness. As a result, the base is large and heavy. Accordingly, the volume of the stone used for the base is increased, leading to an increased cost.

On the other hand, reducing the weight of the base may cause decrease in strength of the base and thereby disable, for example, the guiding unit to appropriately guide the movement mechanism.

The invention has been made in view of the points described above, and aims to achieve a base of a measurement apparatus in which decrease in strength can be prevented while reducing weight.

### Solution to Problem

According to an aspect of the invention, a base of a measurement apparatus configured to measure an object to be measured with a probe is provided. The base includes a placement unit on which the object to be measured is placed and a guiding unit provided on a side surface side of the placement unit. The guiding unit is configured to guide a support configured to support the probe, movable in the movement direction. Guiding unit both ends of the guiding unit in the movement direction extend out of placement unit both ends of the placement unit in the movement direction.

In addition, positions to which the support is movable in the movement direction include a position where an end portion of the support is positioned on the outside of the placement unit both ends.

In addition, the guiding unit both ends may extend out of the placement unit both ends by a length equal to or larger than half a width of the support in the movement direction and smaller than the width of the support.

In addition, an upper surface of the guiding unit may be positioned higher than a placement surface of the placement unit on which the object to be measured is placed.

In addition, a guiding unit bottom surface of the guiding unit that is opposite the upper surface may be flush with a placement unit bottom surface of the placement unit that is opposite the placement surface.

In addition, the guiding unit and the placement unit may be each formed in the shape of a rectangular parallelepiped and the placement unit may be smaller in thickness than the guiding unit.

In addition, the guiding unit and the placement unit may be made from different materials from each other and a material of the placement unit may be lower in rigidity than a material of the guiding unit.

In addition, the guiding unit and the placement unit may be made from the same material, and the guiding unit may have a solid structure and the placement unit may have a hollow structure.

### Advantageous Effects of Invention

According to the invention, it is advantageous that the base of the measurement apparatus in which decrease in strength can be prevented while reducing weight is achieved.

### BRIEF DESCRIPTION OF DRAWINGS

FIG. 1 is a perspective view illustrating a configuration of a three-dimensional measurement apparatus 1 according to an embodiment of the invention.

FIG. 2 is a schematic diagram of a base 10 in FIG. 1 viewed from above.

FIG. 3 is a schematic diagram of the base 10 in FIG. 1 viewed from the front.

FIGS. 4A and 4B are schematic diagrams for explaining a movable range of a column 22.

FIG. 5 is a schematic diagram for explaining a relation between a placement unit 12 and a measurement space.

FIG. 6 illustrates a base 110 according to a comparative example.

### DESCRIPTION OF EMBODIMENTS

### Configuration of Three-Dimensional Measurement Apparatus

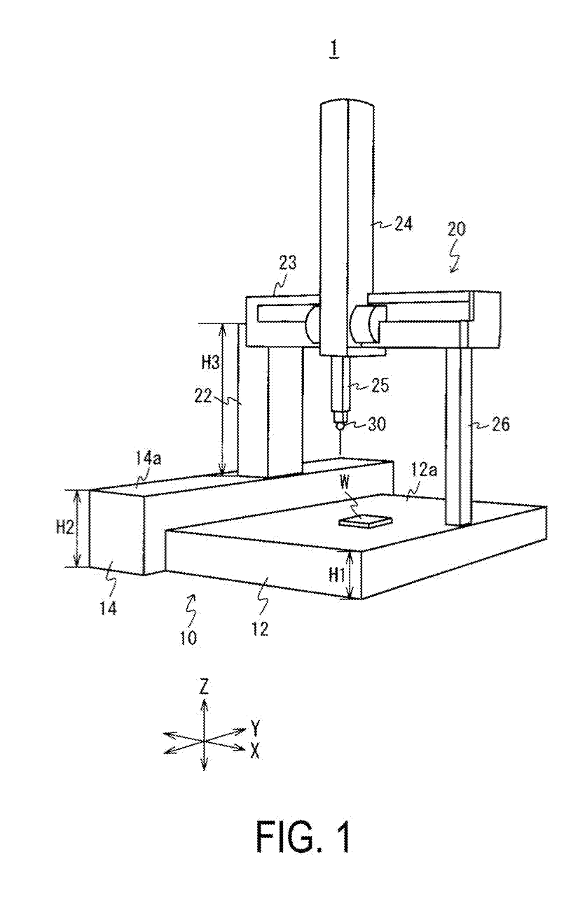

A configuration of a three-dimensional measurement apparatus that is a measurement apparatus in which a base according to an embodiment of the invention is mounted will be described with reference to FIG. 1.

FIG. 1 is a perspective view illustrating the configuration of a three-dimensional measurement apparatus 1 according to the embodiment of the invention. The three-dimensional measurement apparatus 1 includes, as illustrated in FIG. 1, a base 10, a movement mechanism 20, and a probe 30. The three-dimensional measurement apparatus 1 measures a workpiece W that is an object to be measured placed on the base 10 with the probe 30 moved by the movement mechanism 20.

The base 10 is a base of the three-dimensional measurement apparatus 1 and includes a placement unit 12 and a guiding unit 14. As will be described in detail later, the placement unit 12 and the guiding unit 14 are separate parts from each other, and are fixed by a fastening member such as a screw.

The placement unit 12 is in the shape of a rectangular parallelepiped and is a part on which the workpiece W is placed. Specifically, the workpiece W is placed on a placement surface 12a that is an upper surface of the placement unit 12. A space above the placement surface 12a that is a flat surface forms a measurement space in which the probe 30 measures the workpiece W.

The guiding unit 14 is in the shape of a rectangular parallelepiped and guides the movement mechanism 20 (specifically, a column 22) to move in the movement direction (the Y-axis direction in FIG. 1). The longitudinal direction of an upper surface 14a of the guiding unit 14 is along the Y-axis direction.

The movement mechanism 20 is provided on the base 10 and is a mechanism to move the probe 30 in the measurement space. The movement mechanism 20 moves the probe 30 in the X-, Y-, and Z-axis directions in the measurement space with retaining the probe 30. The movement mechanism 20 includes the column 22, a beam 23, a slider 24, and a ram 25.

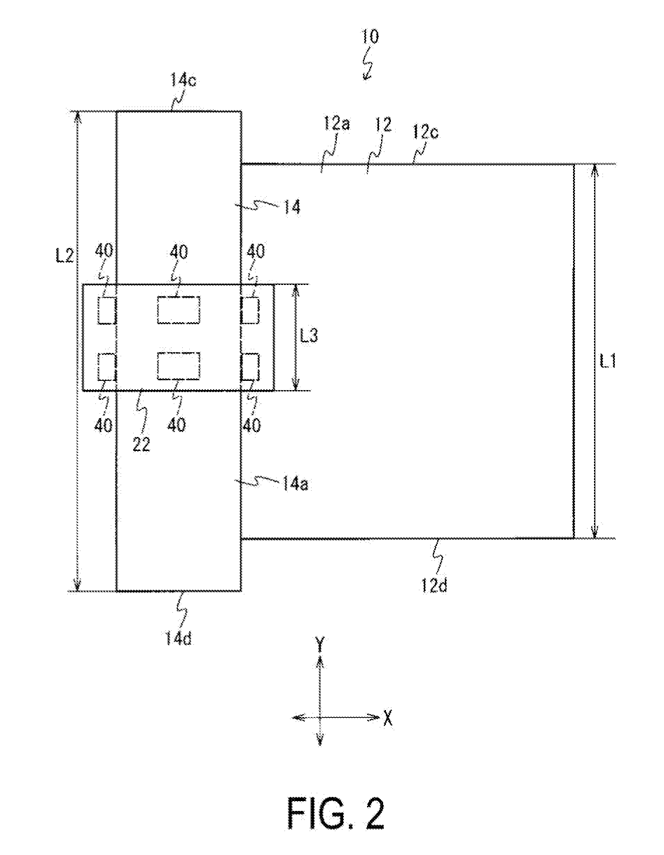

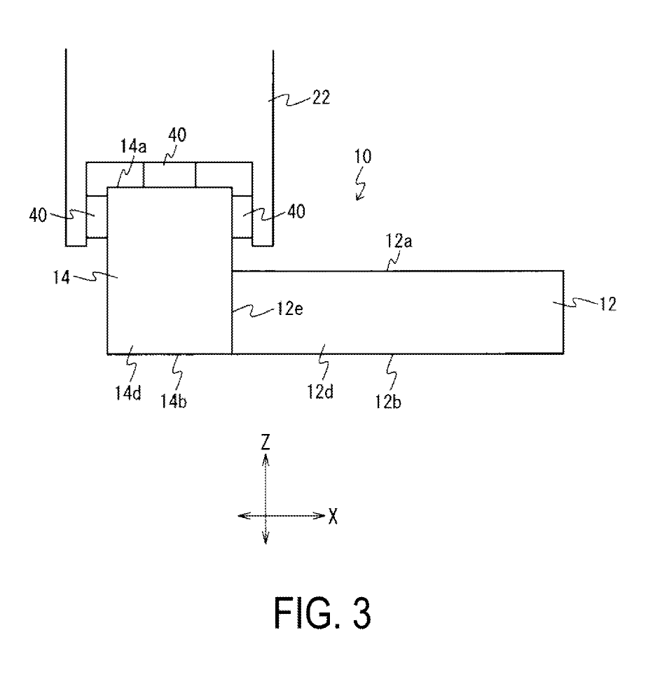

The column 22 is provided on the upper surface 14a of the guiding unit 14 and movable along the Y-axis direction. The column 22 moves in the Y-axis direction with the help of an air pad 40 that is a part of air bearing mechanism (refer to FIGS. 2 and 3). The column 22 moves upon receiving a driving force provided to the guiding unit 14, for example.

The beam 23 is provided so as to extend in the X-axis direction and moves together with the column 22 in the Y-axis direction. One end side of the beam 23 in the longitudinal direction is supported by the column 22, and the other end side of the beam 23 in the longitudinal direction is supported by a supporting column 26. The supporting column 26 is provided on the placement surface 12a and moves together with the column 22 in the Y-axis direction.

The slider 24 is supported by the beam 23 and movable on the beam 23 along the X-axis direction.

The ram 25 is inserted into the slider 24 and moves together with the slider 24 in the X-axis direction. In addition, the ram 25 is movable in the slider 24 along the Z-axis direction.

The probe 30 is a probe to measure the workpiece W placed on the placement surface 12a. For example, the probe 30 moves in contact with the workpiece W to perform scanning measurement on a three-dimensional position of the workpiece W.

### Detailed Configuration of Base 10

As described above, the placement unit 12 and the guiding unit 14 in the base 10 are separate parts from each other. The following describes detailed configuration of the placement unit 12 and the guiding unit 14 with reference to FIGS. 2 to 5.

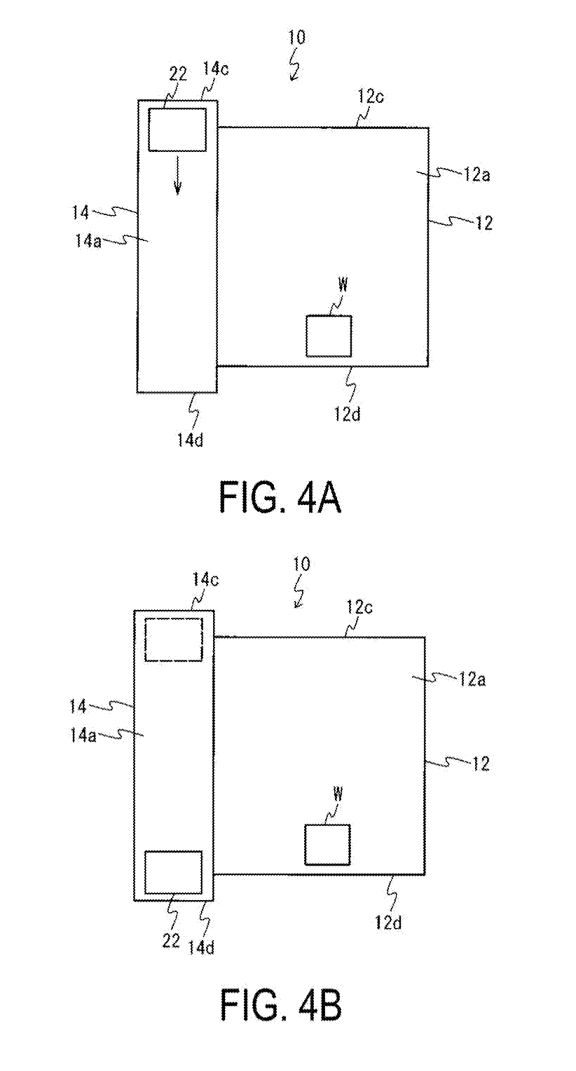

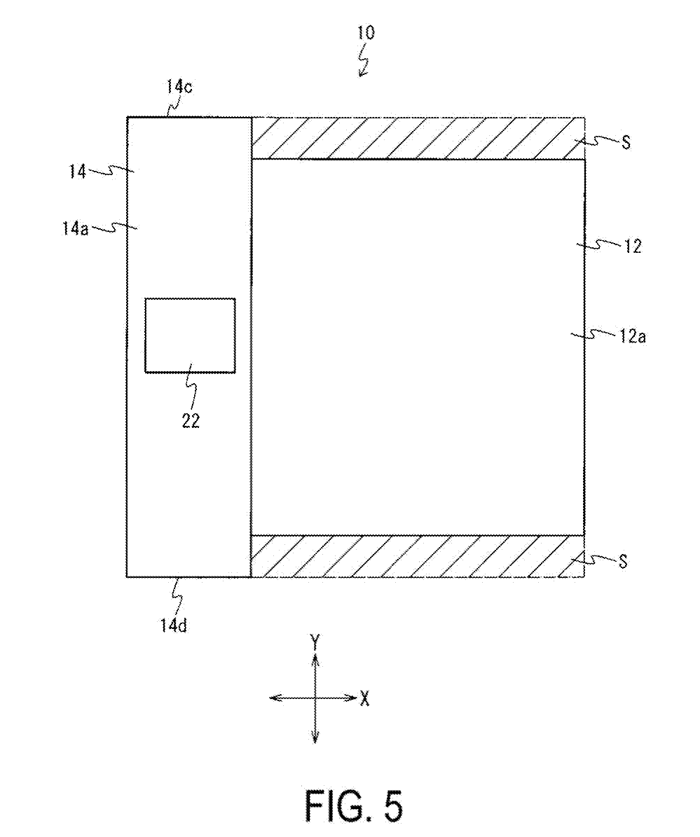

FIG. 2 is a schematic diagram of the base 10 in FIG. 1 viewed from above. FIG. 3 is a schematic diagram of the base 10 in FIG. 1 viewed from the front. FIGS. 4A and 4B are schematic diagrams for explaining a movable range of the column 22. FIG. 5 is a schematic diagram for explaining a relation between the placement unit 12 and the measurement space. The column 22 in FIGS. 4A, 4B, and 5 is illustrated smaller than the column 22 illustrated in FIGS. 2 and 3 for convenience of description.

The placement unit 12 and the guiding unit 14 are each formed in the shape of a rectangular parallelepiped (refer to FIG. 1).

The guiding unit 14 and the placement unit 12 are connected to each other with a side surface 12e of the placement unit 12 (the side surface along the Y-axis direction in FIG. 1) as a contact surface. For example, the guiding unit 14 is fixed to the side surface 12e of the placement unit 12 with a screw or the like.

As illustrated in FIG. 2, the length L2 in the longitudinal direction of the guiding unit 14 (the Y-axis direction in FIG. 2) is larger than the length L1 in the Y-axis direction of the placement unit 12. Specifically, guiding unit both ends of the guiding unit 14 in the Y-axis direction (that is, a guiding unit one end 14c and a guiding unit other end 14d) each extend out of placement unit both ends of the placement unit 12 in the Y-axis direction (that is, a placement unit one end 12c and a placement unit other end 12d).

For example, the guiding unit one end 14c and the guiding unit other end 14d extend out of the placement unit one end 12c and the placement unit other end 12d, respectively, by a length equal to or larger than half the size of the width L3 of the column 22 and smaller than the width L3 of the column 22. Note that, in the Y-axis direction, the distance between the guiding unit one end 14c and the placement unit one end 12c is the same as the distance between the guiding unit other end 14d and the placement unit other end 12d. However, this is not limiting, and the two distances may be different from each other.

In the embodiment, the area of the placement surface 12a is reduced such that the length L1 of the placement unit 12 is smaller than the length L2 of the guiding unit 14. Specifically, as illustrated in FIG. 5, the area of the placement surface 12a is reduced by the hatched parts, spaces S. As described above, the reduced area of the placement surface 12a allows a worker to easily carry in the workpiece W onto the placement surface 12a or easily carry the workpiece W out from the placement surface 12a. In addition, the worker can easily replace the probe 30 manually. The reduced area of the placement surface 12a also downsizes the placement unit 12 and thus allows reduction of the weight of the placement unit 12. Furthermore, the installation area of the base 10 can be reduced by the reduced area of the placement surface 12a.

In addition, when cutting out a structure in which the guiding unit 14 and the placement unit 12 are connected with each other from one stone, significantly many parts need to be cut out. However, in the embodiment, the guiding unit 14 and the placement unit 12 are connected by assembly, thus they do not need to be cut out from a stone. Therefore, machining cost for the guiding unit 14 and the placement unit 12 can be reduced.

A guiding unit bottom surface 14b of the guiding unit 14 that is opposite the upper surface 14a is flush, as illustrated in FIG. 3, with a placement unit bottom surface 12b of the placement unit 12 that is opposite the placement surface 12a. Accordingly, connecting respective side surfaces of the guiding unit 14 and the placement unit 12 configures the base 10.

The placement unit 12 (a length H1 illustrated in FIG. 1) is smaller in thickness than the guiding unit 14 (a length H2). For example, the length H1 of the placement unit 12 is equal to or smaller than two thirds of the length H2 of the guiding unit 14. Accordingly, the weight of the placement unit 12 can be reduced and thus the total weight of the base 10 can be also reduced. On the other hand, because the length H2 of the guiding unit 14 is large, decrease in strength of the guiding unit 14 can be prevented.

The guiding unit 14 and the placement unit 12 may be made from different materials from each other. For example, the guiding unit 14 is made from a high rigidity material and the placement unit 12 is made from a low weight material. In this case, the material of the placement unit 12 is lower in rigidity than the material of the guiding unit 14. This configuration helps to reduce the weight of the placement unit 12 while securing strength of the guiding unit 14. That is, in comparison with the case in which the guiding unit 14 and the placement unit 12 are made from a single material, the total weight of the base 10 is easily reduced.

The upper surface 14a of the guiding unit 14 is positioned, as illustrated in FIG. 3, higher than the placement surface 12a of the placement unit 12. Accordingly, in the Z-axis direction (refer to FIG. 1), the distance between the upper surface 14a and the beam 23 of the movement mechanism 20 is reduced, and thus the length of the column 22 disposed between the upper surface 14a and the beam 23 of the movement mechanism 20 in the height direction (a length H3) is reduced. As a result, torsional rigidity of the column 22 is increased and controlling at high acceleration or deceleration when the driving source moves the column 22 is enabled. In addition, because rigidity of the column 22 is increased, the intervals, i.e., distances, between six air pads 40 that support the column 22 (FIG. 2) can be reduced. The length of the upper surface 14a is determined by the installation positions of the air pads 40. Reducing the intervals between the six air pads 40 can reduce the length L2 of the upper surface 14a.

In addition, reducing the length H3 of the column 22 reduces the weight of the column 22. Accordingly, the driving force of a motor that is the driving source to move the column 22 can be reduced, whereby power consumption of the motor can be reduced. As a result, a small-sized motor can be employed as the driving source, whereby cost reduction for the driving source can be sought.

In addition, reducing the length H3 of the column 22 also reduces the volume of the column 22. If the column 22 is a casting, for example, reducing the volume of the column 22 can reduce an amount of molten metal to be poured into a mold, thereby, reducing manufacturing cost for the column 22.

Positions to which the column 22 is movable in the Y-axis direction with respect to the above-described base 10 include, as illustrated in FIGS. 4A and 4B, positions where an end portion of the column 22 is positioned on the outside of the placement unit one end 12c and the placement unit other end 12d. The position illustrated in FIG. 4A is the position nearest to the most one end side when the column 22 measures in the Y-axis direction. The position illustrated in FIG. 4B is the position nearest to the most other end side when the column 22 measures in the Y-axis direction. The positions to which the column 22 is movable are positions allowing use of entire of the placement surface 12a without waste as the measurement space. Accordingly, in the placement surface 12a, occurrence of a dead space not used for the measurement space can be prevented.

In the above description, the guiding unit 14 and the placement unit 12 are made from different materials from each other. However, this is not limiting. For example, the guiding unit 14 and the placement unit 12 may be made from the same material. In this case, the guiding unit 14 may have a solid structure and the placement unit 12 may have a hollow structure. This configuration helps to reduce the weight of the placement unit 12 while securing the strength of the guiding unit 14. Note that the guiding unit 14 and the placement unit 12 may have a hollow structure (for example, a honeycomb structure). Accordingly, the weight can be reduced while increasing the strength.

### Advantageous Effects in the Embodiment

In the base 10 of the three-dimensional measurement apparatus 1 described above, the placement unit 12 on which the workpiece W is placed and the guiding unit 14 configured to guide the column 22 to move in the movement direction (the Y-axis direction in FIG. 1) are separate parts from each other. In addition, the guiding unit both ends of the guiding unit 14 in the movement direction (the guiding unit one end 14c and the guiding unit other end 14d) extend out of the placement unit both ends of the placement unit 12 in the movement direction (the placement unit one end 12c and the placement unit other end 12d).

Accordingly, because the length L1 of the placement unit 12 is smaller than the length L2 of the guiding unit 14 in the Y-axis direction, the placement unit 12 can be downsized. As a result, the total weight of the base 10 can be reduced.

In addition, in the embodiment, the length H1 of the placement unit 12 in the height direction is smaller than the length H2 of the guiding unit 14 in the height direction. That is, by making the placement unit 12 thinner than the guiding unit 14, decrease in strength of the guiding unit 14 can be prevented while reducing the weight of the placement unit 12. As a result, in the base 10, decrease in strength can be effectively prevented while reducing weight.

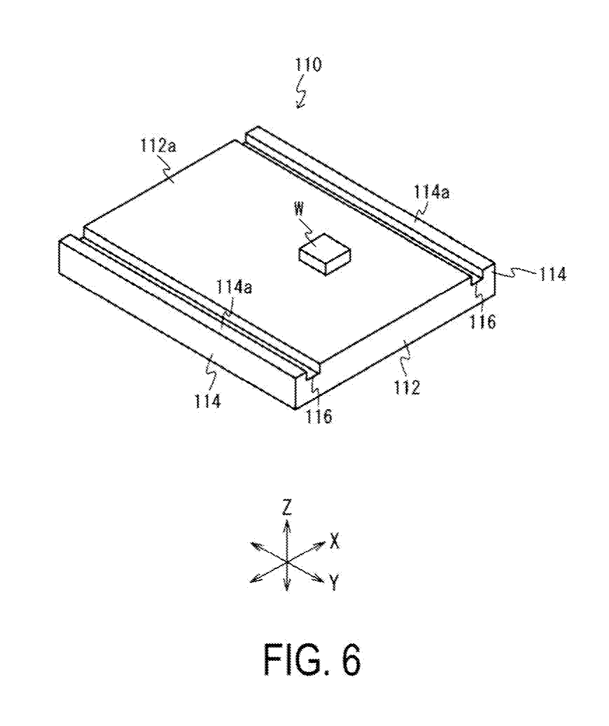

Here, this will be further described with reference to a comparative example illustrated in FIG. 6.

FIG. 6 illustrates a base 110 according to the comparative example. The base 110 is made from a single material, and a placement unit 112 and a guiding unit 114 are integrated with each other. In addition, in between the placement unit 112 and the guiding unit 114, a groove portion 116 is formed to help guiding the above-described movement mechanism 20. The base 110 is manufactured by cutting the groove portion 116 out of a rectangular parallelepiped part, for example.

In the comparative example, the length of the placement unit 112 is equal to the length of the guiding unit 114 in the Y-axis direction. In addition, the placement surface 112a of the placement unit 112 and a guiding surface 114a of the guiding unit 114 are flush with each other. The base 110 is made from the single material; thus, if securing strength of the guiding unit 114 is sought, weight of the base 110 is increased. On the other hand, if reducing the weight of the base 110 is sought, thickness of the guiding unit 114 needs to be reduced, thus leading to decrease in strength.

In contrast, in the embodiment described above, the placement unit 12 and the guiding unit 14 are separate parts and are different in size from each other. This configuration achieves reduced weight of the base 10 while securing the strength of the guiding unit 14.

In the above description, the probe 30 is a contact probe configured to come into contact with the workpiece W. However, this is not limiting. For example, the probe 30 may be a non-contact probe such as a laser probe and a camera probe.

In addition, in the above description, the movement mechanism 20 moves the probe 30 in each axial direction of orthogonal three-axis directions. However, this is not limiting. For example, the movement mechanism 20 may move the probe 30 in any one or two axial directions of the X-, Y-, and Z-axis directions. In addition, a rotation mechanism may be provided to the placement unit 12 to rotate the workpiece W.

In addition, in the above description, the column 22 moves with the help of the air pads 40 in the Y-axis direction. However, this is not limiting. For example, the column 22 may be guided by a linear guide in the Y-axis direction.

In addition, in the above description, the movement mechanism 20 has a gate structure as illustrated in FIG. 1. However, this is not limiting. The movement mechanism 20 may have another structure if the movement mechanism 20 is movable with supporting the probe 30.

While the invention has been described with reference to the embodiment, the technical scope of the invention is not limited to the scope described in the above embodiment, and various modifications and changes are possible within the spirit and scope of the invention. For example, specific embodiments of distribution or integration of the apparatus are not limited to the above embodiment, and all or a part thereof may be configured to be distributed or integrated functionally or physically in any units. In addition, any new embodiment generated by any combination of a plurality of embodiments is also included in the embodiment of the invention. The effects of the new embodiment generated by such a combination also have the effects of the original embodiment.

### REFERENCE SIGNS LIST

1 THREE-DIMENSIONAL MEASUREMENT APPARATUS
10 BASE
12 PLACEMENT UNIT
12a PLACEMENT SURFACE
12b PLACEMENT UNIT BOTTOM SURFACE
12c PLACEMENT UNIT ONE END
12d PLACEMENT UNIT OTHER END
12e SIDE SURFACE
14 GUIDING UNIT
14a UPPER SURFACE
14b GUIDING UNIT BOTTOM SURFACE
14c GUIDING UNIT ONE END
14d GUIDING UNIT OTHER END
22 COLUMN
30 PROBE
W WORKPIECE

1. A base of a measurement apparatus configured to measure an object to be measured with a probe, the base of the measurement apparatus comprising:
a placement unit on which the object to be measured is placed; and
a guiding unit provided on a side surface side of the placement unit, the guiding unit being configured to guide a support configured to support the probe, movable in a movement direction, wherein guiding unit both ends of the guiding unit in the movement direction extend out of placement unit both ends of the placement unit in the movement direction.

2. The base of the measurement apparatus according to claim 1, wherein positions to which the support is movable in the movement direction include a position where an end portion of the support is positioned on the outside of the placement unit both ends in the movement direction.

3. The base of the measurement apparatus according to claim 1, wherein the guiding unit both ends extend out of the placement unit both ends by a length equal to or larger than half a width of the support in the movement direction and smaller than the width of the support.

4. The base of the measurement apparatus according to claim 1, wherein an upper surface of the guiding unit is positioned higher than a placement surface of the placement unit on which the object to be measured is placed.

5. The base of the measurement apparatus according to claim 4, wherein a guiding unit bottom surface of the guiding unit that is opposite the upper surface is flush with a placement unit bottom surface of the placement unit that is opposite the placement surface.

6. The base of the measurement apparatus according to claim 4, wherein
the guiding unit and the placement unit are each formed in a shape of a rectangular parallelepiped; and
the placement unit is smaller in thickness than the guiding unit.

7. The base of the measurement apparatus according to claim 1, wherein
the guiding unit and the placement unit are made from different materials from each other; and
a material of the placement unit is lower in rigidity than a material of the guiding unit.

8. The base of the measurement apparatus according to claim 1, wherein
the guiding unit and the placement unit are made from the same material; and
the guiding unit has a solid structure and the placement unit has a hollow structure.
